(19) United States
(12) Patent Application Publication
(10) Pub. No.: US 2008/0228658 A1
(43) Pub. Date: Sep. 18, 2008

(54) DEAL IDENTIFICATION SYSTEM

(76) Inventors: Hugh Crean, Seattle, WA (US); Michael Fridgen, Seattle, WA (US); Jay Bartot, Seattle, WA (US); Kristine Marshall, Seattle, WA (US); Gunnar Sigurdsson, Seattle, WA (US); Leon Stein, Palm Harbor, FL (US)

Correspondence Address: PERKINS COIE LLP;PATENT-SEA, P.O. BOX 1247, SEATTLE, WA, 98111-1247, US

(21) Appl. No.: 12/048,154

(22) Filed: Mar. 13, 2008

Related U.S. Application Data
(60) Provisional application No. 60/906,929, filed on Mar. 13, 2007.

(51) Int. Cl. H04K 1/00

(52) U.S. Cl. 705/80

(57) ABSTRACT

A method and system for identifying deals to facilitate travel planning is provided. In one embodiment, a deal identification system identifies deals on travel items and presents those deals to a person in a way that facilitates travel planning and travel shopping. The deal identification system may include an entity attributes service component that provides attributes of entities associated with the items. The deal identification system may also include a historical price service component that provides historical pricing information for the items. The deal identification system may also include a deal component that receives a criterion that defines a deal based on a combination of attributes of entities, historical pricing information, and current pricing information and identifies those items that match the criterion as deals.

### CROSS-REFERENCE TO RELATED APPLICATION(S)

This application claims the benefit of U.S. Provisional Patent Application No. 60/906,929, entitled “DEAL IDENTIFICATION SYSTEM,” filed on Mar. 13, 2007, which application is hereby incorporated by reference in its entirety.

### BACKGROUND

In many situations, potential buyers or other acquirers of various types of items (such as products and/or services) are faced with difficult decisions when attempting to determine whether acquiring a particular item of interest under current conditions is desirable or optimal based on their goals, or whether instead delaying the acquisition would be preferable. For example, when the potential acquirer desires to obtain the item at the lowest price possible before some future date, and the item is currently offered by a seller for a current price, the potential acquirer needs to evaluate whether accepting the current price is more advantageous than the potential benefits and costs associated with waiting to see whether the item will continue to be available and will be later offered at a lower price before the future date. Such potential acquisitions can include a variety of types of transactions (e.g., fixed-price purchase, auction-based purchase, reverse auction purchase, name-your-price purchase, rent, lease, license, trade, evaluation, sampling, etc.), and can be performed in a variety of ways (e.g., by online shopping using a computing device, such as via the World Wide Web or other computer network).

The difficulty of evaluating a potential current item acquisition is exacerbated in environments in which the prices of the items frequently change, such as when sellers or other suppliers of the items frequently modify item prices (e.g., in an attempt to perform yield management and maximize overall profits). The prices of items may change frequently when the items are of a limited quantity and are perishable (e.g., concert tickets and airline tickets). In such environments, the likelihood of future price changes may be high or even a certainty, but it may be difficult or impossible for the potential acquirer to determine whether the future price changes are likely to be increases or decreases, let alone the likely magnitude and timing of such changes. A large number of types of items may have such frequent price changes, such as airline tickets, car rentals, hotel rentals, gasoline, food products, jewelry, various types of services, etc. Moreover, a potential acquirer may in some situations need to evaluate not only a current price of an item of interest from a single seller or other provider, but also may need to consider prices offered by other providers and/or prices for other items that are sufficiently similar to be potential substitutes for the item of interest (e.g., airline flights with the same route that leave within a determined period of time, whether from the same airline or from competitor airlines).

Some systems attempt to identify a good buy for an item by comparing the price of the item offered by one supplier to the prices offered by other suppliers. If one of the suppliers offers the item at a price that is significantly lower than other suppliers, then the price from that supplier might be considered to be a good buy. Unfortunately, such a “good buy” is only relative to the current prices at which the item is being offered.

### BRIEF DESCRIPTION OF THE DRAWINGS

FIGS. 1 and 2 provide web pages with a description of how the deal identification system functions from a user's perspective in one embodiment.

FIG. 3 illustrates a web page describing current deals.

FIG. 4 illustrates a web page describing current deals in different trip categories.

FIG. 5 is a block diagram that illustrates the overall architecture of the deal identification system.

FIG. 6 is a block diagram that illustrates a hierarchy of components of the deal identification system in one embodiment.

FIG. 7 is a diagram that illustrates a tag table of the deal identification system in one embodiment.

FIG. 8 is a block diagram that illustrates a logical organization of data used by the entity ranking service and the histogram service to generate the rankings and histograms.

FIG. 9 is a block diagram that illustrates ranking tables generated by the entity ranking service.

FIG. 10 is a block diagram that illustrates a current fare table in one embodiment.

FIG. 11 is a block diagram that illustrates data structures of an observation store in one embodiment.

FIG. 12 is a diagram that illustrates a fare histogram.

FIG. 13 is a block diagram that illustrates a campaign table of the campaign service.

FIG. 14 is a flow diagram that illustrates the processing of an identify deals component of the deal identification system in some embodiments.

FIG. 15 is a flow diagram that illustrates the processing of a generate histogram component of the deal identification system in some embodiments.

FIG. 16 is a flow diagram that illustrates the processing of a generate ranking component of the deal identification system in some embodiments.

### DETAILED DESCRIPTION

A method and system for identifying deals to facilitate travel planning is provided. In one embodiment, a deal identification system identifies deals on travel items and presents those deals to a person in a way that facilitates travel planning and travel shopping. The travel items may be airline trips, hotel rooms, rental cars, ship cruises, travel packages, or other travel-related items. The deal identification system may include an entity attributes service component that provides attributes of entities associated with the items. For example, an entity associated with an airline flight may be a destination city and an attribute may indicate whether the city is near a ski resort. The deal identification system may also include a historical price service component that provides historical pricing information for the items. For example, the historical pricing information may include the price for an airline flight sampled on a daily basis over the past year. The deal identification system may also include a current price service component that provides current pricing information for the items (e.g., current airfare of a flight). The deal identification system may also include a deal component that receives a criterion that defines a deal based on a combination of attributes of entities, historical pricing information, and current pricing information and identifies those items that match the criterion as deals.

The deal identification system may also identify deals based solely on non-pricing attributes of an item or based on a combination of pricing and non-pricing attributes. For example, the non-pricing attributes of an airline flight may include physical characteristics of the airplane (e.g., leg room, head room, and fabric of seats), characteristics of the airlines (e.g., financial strength), characteristics of the flight (e.g., on-time performance, number of stops, and layover time), characteristics of the airport (e.g., rental car locations and dining options), and so on. The deal identification system may allow a person to provide a criterion that defines items that match the criterion and defines a deal for the matching items based on non-pricing attributes of the matching items. For example, a deal may be considered to be an airline flight that is non-stop when all other comparable flights have at least one stop. The deal identification system identifies the items that match the criterion. For example, all flights between the same cities may match the criterion. The deal identification system then evaluates the attributes of the matching items to determine whether there are any deals.

The deal identification system may collect the travel information from various travel information sources (e.g., Sabre, ITA Software, airlines, or hotels). The deal identification system may collect that information at a specified observation rate (e.g., weekly, once daily, and twice daily) or at a variable observation rate (e.g., weekly during a low demand period and daily during a high demand period). If the travel information is collected more often than daily, then an observation date and time may be associated with each collection of travel information, referred to as an “observation.” The deal identification system stores the travel information in an observation store. The deal identification system is described below in the context of flight information.

In one embodiment, the deal identification system (or a system accessible by the deal identification system) collects observations of flight information for all possible trips on a daily basis and stores the flight information in association with its observation date. A trip is defined as a particular market and a particular departure and return date combination. For example, a market may be Seattle to Boston, Boston to Seattle, or Seattle to San Francisco. A departure and return date combination may be January 1 and January 5 or January 2 and January 5. Continuing with the example, one trip might be from Seattle to Boston departing on January 1 and returning on January 5, another trip might be from Seattle to Boston departing on January 2 and returning on January 5, and another trip might be from Boston to Seattle departing on January 2 and returning on January 5. Each trip may have multiple available flights. For example, the trip from Seattle to Boston departing on January 1 and returning on January 5 may have four available flights. Airline A may have a flight that departs at 6 a.m. on January 1 and returns at 5 p.m. on January 5, and a flight that departs at 6 a.m. on January 1 and returns at 10 p.m. on January 5. Airline B may have a flight that departs at 10 a.m. on January 1 and returns at 12 p.m. on January 5, and a flight that departs at 3 p.m. on January 1 and returns at 12 p.m. on January 5. An observation of a trip is flight information relating to all the flights of the trip. Each observation has an associated observation date that is the date the flight information for the flights of a trip was collected. For example, on December 20, the deal identification system may collect the flight information for all flights from Seattle to Boston departing on January 1 and returning on January 5. In such a case, the observation includes flight information for the four flights of Airlines A and B with an observation date of December 20. If on the next day, December 21, the deal identification system collects the flight information for the same trip, it will have another observation for the trip but with an observation date of December 21. The deal identification system may collect flight information for each flight that includes market, departing date and time, return date and time, airline, available seats, classes of available seats, number of stops, ticket restrictions, and so on. The flight information may be collected directly from the airlines or from an aggregation service that aggregates flight information for multiple airlines. The deal identification system may collect the observations for all trips on a daily basis and store the observations in an observation store.

In one embodiment, the deal identification system may collect flight information on a daily basis for each market. The deal identification system may limit the flights for which it retrieves flight information to flights that depart in the next 90 days and that are for durations of 2 to 8 days. One skilled in the art will appreciate that the retrieved flight information can be for any number of departure date and duration length combinations. Thus, for each market, the deal identification system will collect flight information for 630 trips (e.g., 90*7). The 630 possible trips are illustrated in the following table.

| Trip Number | Departure Date | Return Date |
|---|---|---|
| 1 | 1 | 3 |
| 2 | 1 | 4 |
| 3 | 1 | 5 |
| . . . | | |
| 7 | 1 | 9 |
| 8 | 2 | 4 |
| 9 | 2 | 5 |
| . . . | | |
| 14 | 1 | 10 |
| 15 | 3 | 5 |
| . . . | | |
| 623 | 89 | 97 |
| 624 | 90 | 92 |
| 625 | 90 | 93 |
| . . . | | |
| 630 | 90 | 98 |

The deal identification system can also be used to identify hotel-related deals. The hotel rooms for a particular hotel market (e.g., city and hotel rating) may be aggregated in a manner similar to the way in which the airline flight information for a flight market (e.g., departure location and return location combination) is aggregated. For example, the four-star hotels in New York City can represent one market, the one-star hotels in New York City can represent another market, the four-star hotels in Las Vegas can represent yet another market, and so on. The hotel markets could further be divided into type of room (e.g., single king-size bed, two double beds, suite). Alternatively, the type of room could simply be a feature of the feature vector representing hotel rooms in the market. The deal identification system can collect hotel information on a daily or other basis for various stays in each market similar to the way in which information for airline trips is collected. A stay may be a particular arrival and departure date combination for a market. For example, one stay may be arriving on January 1 and departing on January 5 for a four-star hotel in New York City, another stay may be arriving on January 1 and leaving on January 3 for a four-star hotel in New York City, and yet another stay may be arriving on January 1 and departing on January 5 for a one-star hotel in Las Vegas.

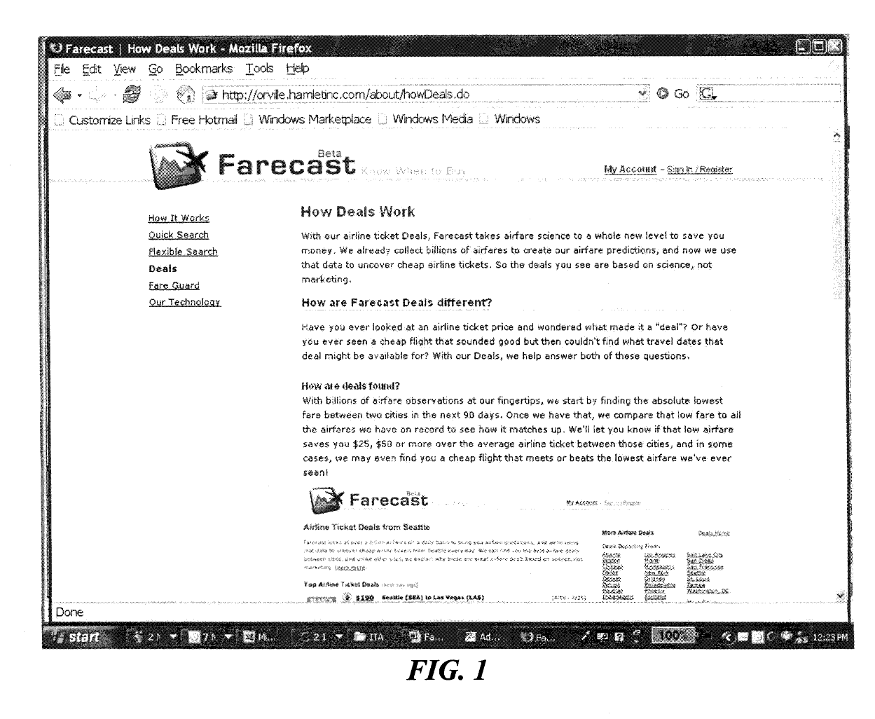

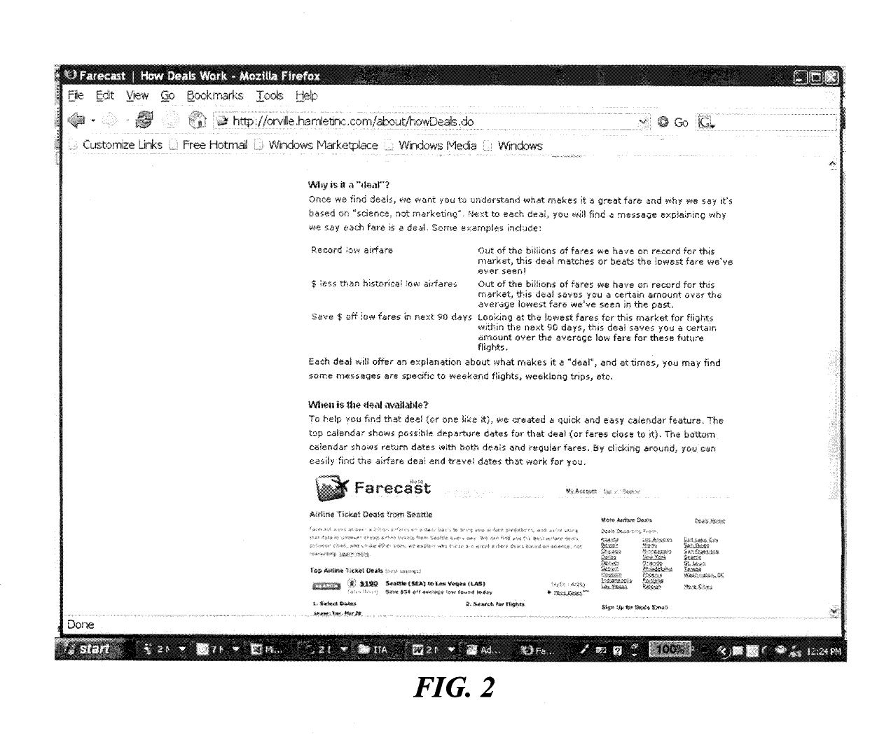

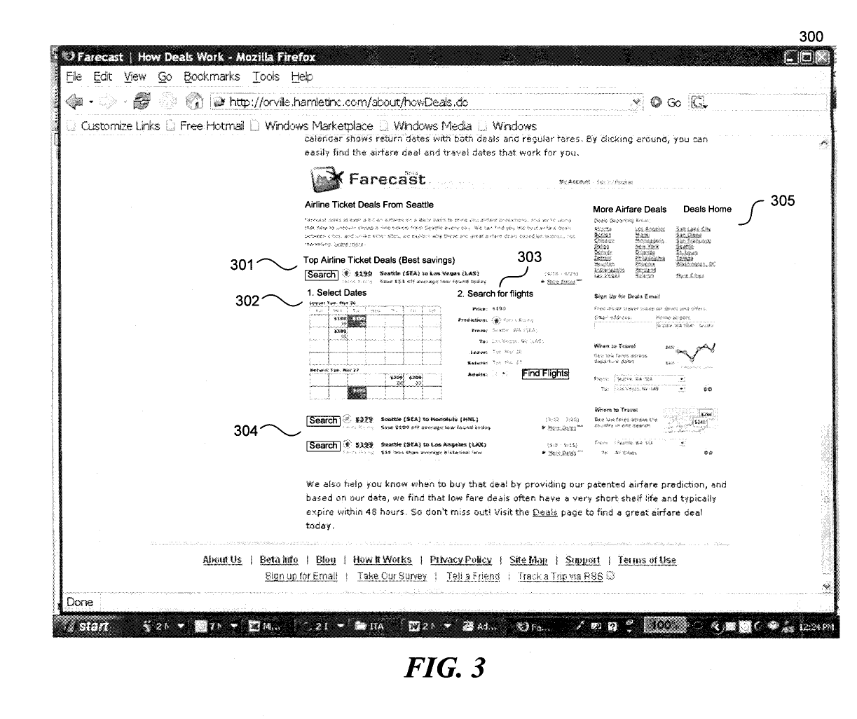

In one embodiment, the deal identification system may analyze fares on a daily basis for departures in the next 90 days to determine what fares can be classified as deals. FIGS. 1 and 2 provide web pages with a description of how the deal identification system functions from a user's perspective in one embodiment. FIG. 3 illustrates a web page describing current deals. Web page 300 illustrates a deal for the market Seattle to Las Vegas. A deal identification area 301 identifies the deal, and a calendar area 302 provides a visual representation of the departure and return dates of the deal. A deal information area 303 provides a summary of the trip and its fare. Another deals area 304 presents additional deals to the user. In this example, the user may live in Seattle, and the deal identification system automatically identifies deals for markets departing from Seattle. A departing city area 305 provides a list of departure cities that the user may select to view deals for other departure cities.

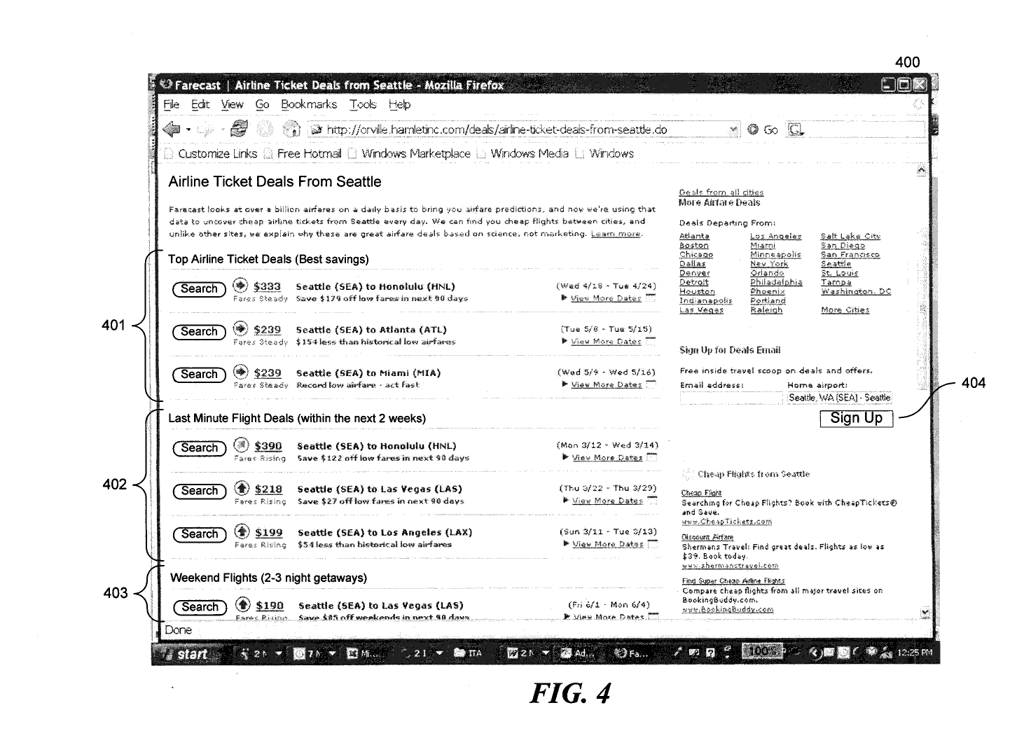

FIG. 4 illustrates a web page describing current deals in different trip categories. Web page 400 includes a top airline ticket deals area 401, a last-minute flight deals area 402, and a weekend flight deals area 403. By categorizing the trips that are deals, the deal identification system facilitates locating a deal of interest. Web page 400 also includes an alert area 404 in which a user can sign up to receive e-mail alerts of deals.

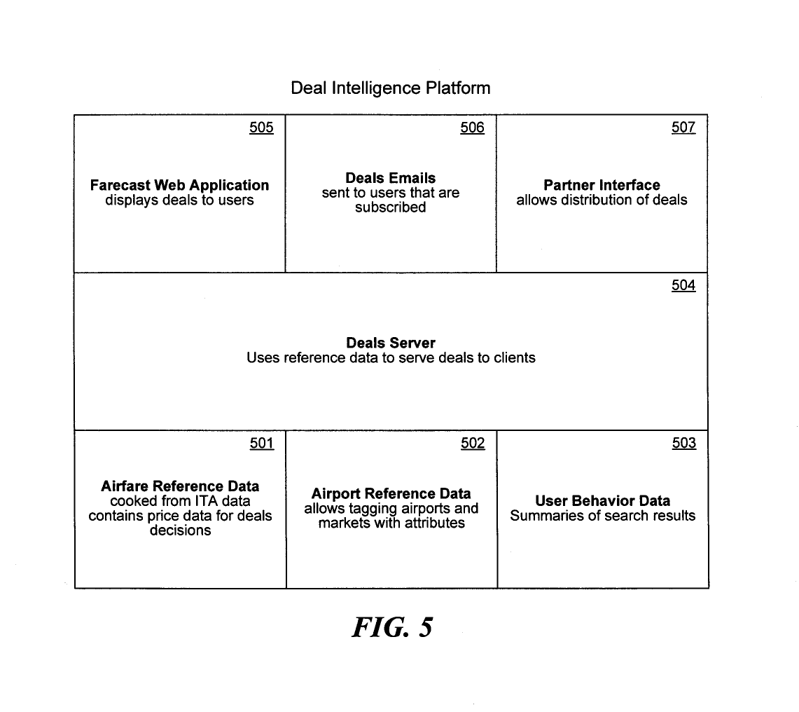

FIG. 5 is a block diagram that illustrates the overall architecture of the deal identification system. An airfare reference data component 501, an airport reference data component 502, and a user behavior data component 503 provide data for a deals server 504 that identifies the deals. The deals server then provides indications of deals to various interfaces such as a web application interface 505, an e-mail interface 506, and a partner interface 507. The component 501 collects the fare data or observations from the various flight information sources. The component 502 provides a user interface through which an administrator can identify various attributes of airports. For example, as described below in more detail, an airport may have an attribute that it is a good ski destination, beach destination, camping destination, and so on. The component 503 provides summary information of user behavior. The component 503 may input flight queries submitted by users, the corresponding search results, clickthrough data, and so on and then generate various statistics or summaries about that data. The deals server 504 may provide a user interface through which an administrator can define deals using deal criteria. For example, a deal criterion may define a deal to be a flight with a current fare that is within 10% of its all-time lowest fare for that market. As another example, a ski deal criterion may define a ski deal to be a flight to a destination city that is a known ski destination with a fare that is the all-time lowest fare. The deals server identifies deals that satisfy the deal criteria and provides those deals to the interfaces. The interface 505 is a web application that displays deals to users. The interface 506 provides the deals via an electronic mail system to users. The interface 507 may provide an application programming interface through which web sites may obtain deal information to be displayed on web pages of those web sites.

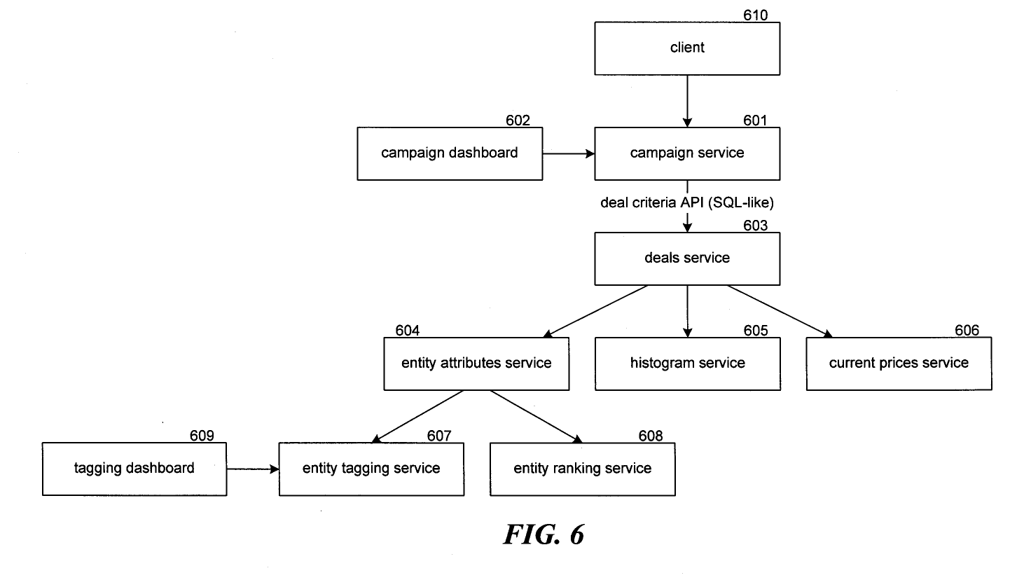

FIG. 6 is a block diagram that illustrates a hierarchy of components of the deal identification system in one embodiment. The deal identification system includes a campaign service 601 that interfaces with a client 610 to define and identify deals. The campaign service 601 interfaces with a campaign dashboard 602 and a deals service 603. The deals service interfaces with an entity attributes service 604, a histogram service 605, and a current prices service 606. The entity attributes service interfaces with an entity tagging service 607 and an entity ranking service 608. The entity tagging service interfaces with a tagging dashboard 609.

The entity tagging service allows an administrator via a tagging dashboard to tag entities (e.g., airports or cities) with various attributes. The tagging dashboard allows an administrator to define arbitrary attributes. For example, the attributes may indicate whether a city is a ski destination, a beach destination, and so on. In addition, the tag may provide a score for that attribute for the airport. For example, Las Vegas may have a score of 1.0 for a gambling attribute, but a score of 0 for a ski attribute.

The entity ranking service ranks various markets and airports based on their popularity. For example, the market of Los Angeles to Las Vegas is likely more popular than the market of Los Angeles to Jersey City. Each airport may be scored based on its popularity of being a departing airport and a destination airport. The entity ranking service may generate the statistics or rankings aggregated for all users and may generate the rankings on a per-user basis. For example, a user who travels frequently from Seattle to San Francisco will have a high ranking score for the market Seattle to San Francisco, a high score for Seattle as a departure city, and a high score for San Francisco as a destination city.

The histogram service generates statistical information from the observation data that has been collected in the observation store. The histogram service generates a histogram for each trip classification. For example, the histogram service may generate a histogram for each market that accumulates for various fare levels the number of days over time that the lowest fare for that market was at that fare level. For example, the histogram service may bucketize the fares into $50 increments. For example, the buckets would be from $1 to $49, $50 to $99, $100 to $149, and so on. Each bucket for a market contains the count of the number of days that the lowest fare for observations taken on that day was in that bucket. The histogram service may generate the histogram for an all trips category, a weekend trips category, a weeklong trips category, and so on.

The current prices service retrieves the current fares for flights from the flight information sources in real time.

The deals service receives from the campaign service SQL-type statements defining a criterion of a deal, identifies flights that satisfy the criterion, and returns an indication of those flights that satisfy the criterion. The campaign service allows an administrator to define the criteria for various deals. The campaign service provides a campaign dashboard user interface through which an administrator inputs the criterion for a deal, which may include a filter specification and an order specification. The filter specification defines the flights that are deals, and the order specification defines how the flights are to be ordered when presented to a user. The campaign service receives requests for deals and submits the filters to the deals service. The campaign service sorts the results provided by the deals service and provides them to the clients.

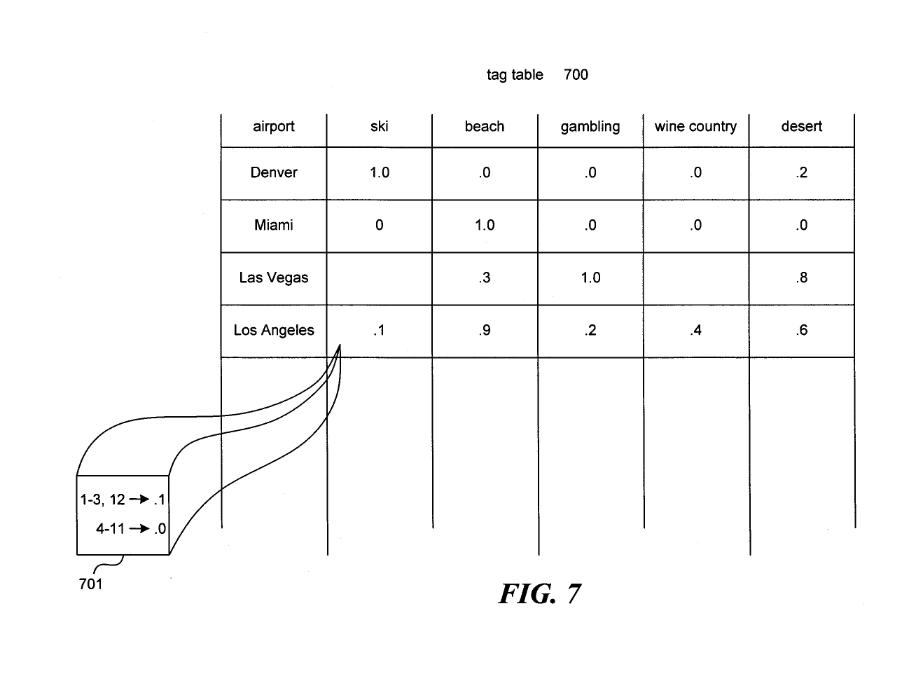

FIG. 7 is a diagram that illustrates a tag table 700 of the deal identification system in one embodiment. The tag table 700 is generated by the entity tagging service. The tag table contains a row for each airport and a column for each tag or attribute that has been defined by an administrator using the tagging dashboard. In this example, the tags are ski, beach, gambling, wine country, and desert. Each entry is a score indicating a rating of the airport to that attribute. For example, Denver has a ski rating of 1.0, but a beach rating of 0. The entity tagging service may allow a user to specify the range of months or days for the various scores of an attribute. For example, Los Angeles may be given a ski score of 0.1 during the winter months because of the snow in the local mountains and a ski rating of 0 during other months as indicated by field 701.

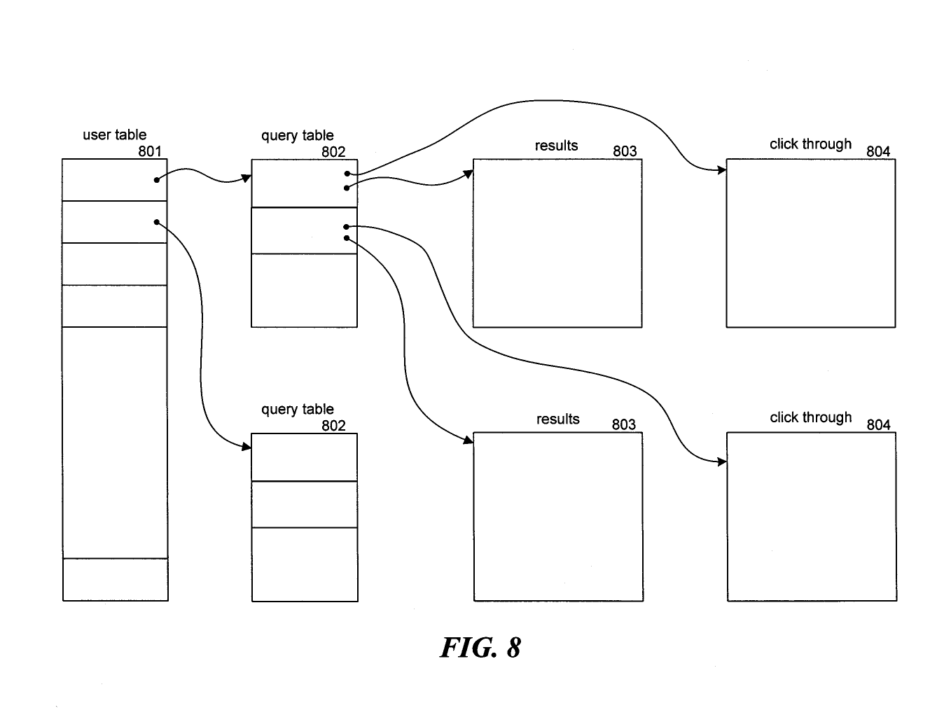

FIG. 8 is a block diagram that illustrates a logical organization of data used by the entity ranking service and the histogram service to generate the rankings and histograms. The data includes a user table 801 that has an entry for each user. Each entry points to a query table 802 that contains an entry for each flight query submitted by a user. Each entry of the query table contains a reference to a results data structure 803 and a clickthrough table 804. The results data structure identifies the results presented to the user as a result of that query. The clickthrough table contains an entry for each click the user made to an item of the results for that query.

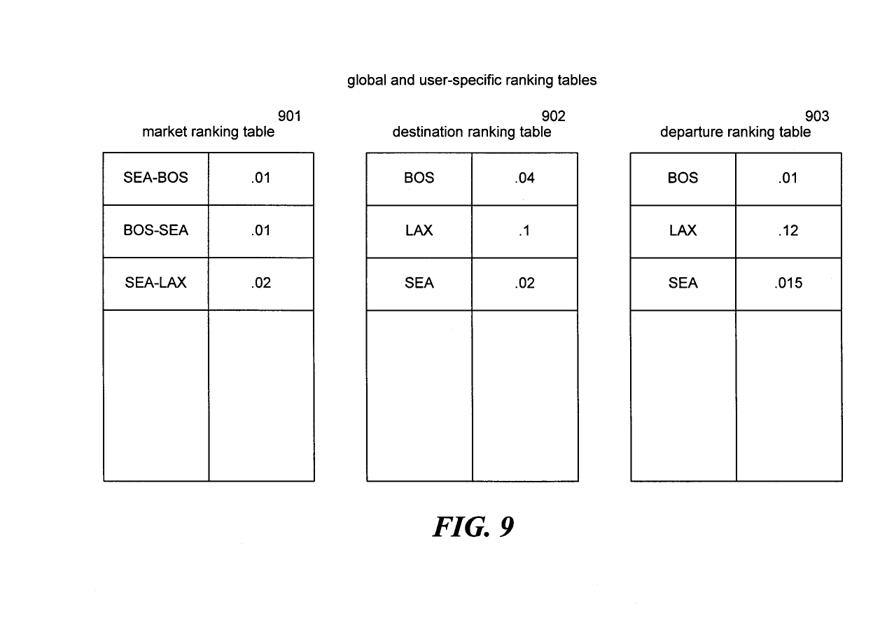

FIG. 9 is a block diagram that illustrates ranking tables generated by the entity ranking service. The ranking tables may include a market ranking table 901, a destination ranking table 902, and a departure ranking table 903. The entity ranking service may generate global ranking tables and ranking tables for each user. The market ranking table contains an entry for each market along with a ranking for that market, as may be indicated by a percentage of the total flights that are within that market. The destination ranking table contains an entry for each airport along with a score indicating the popularity of that airport as a destination. The departure ranking table contains an entry for each airport along with a score indicating the popularity of that airport as a departure airport.

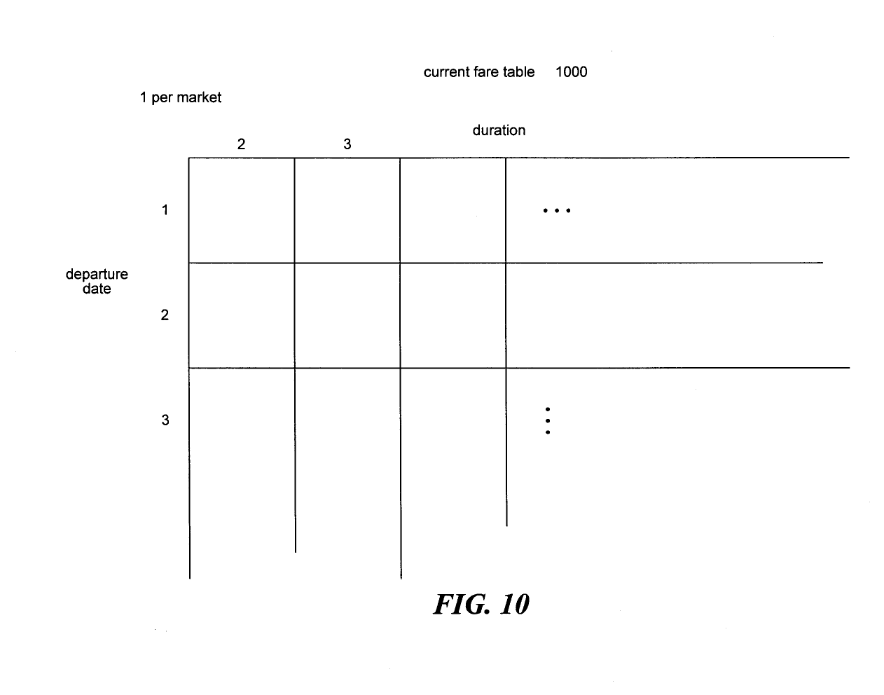

FIG. 10 is a block diagram that illustrates a current fare table in one embodiment. The deal identification system may maintain a current fare table 1000 for each market. The current fare table may have a row for each of the 90 departure dates of an observation and a column for each of the possible durations of flights leaving on that departure date. An entry of the current fare table indicates the current lowest fare for that departure date and the duration. The deal information system may in real time retrieve information from the flight information source to identify the actual current fare, which may have changed, and update the current fare table accordingly.

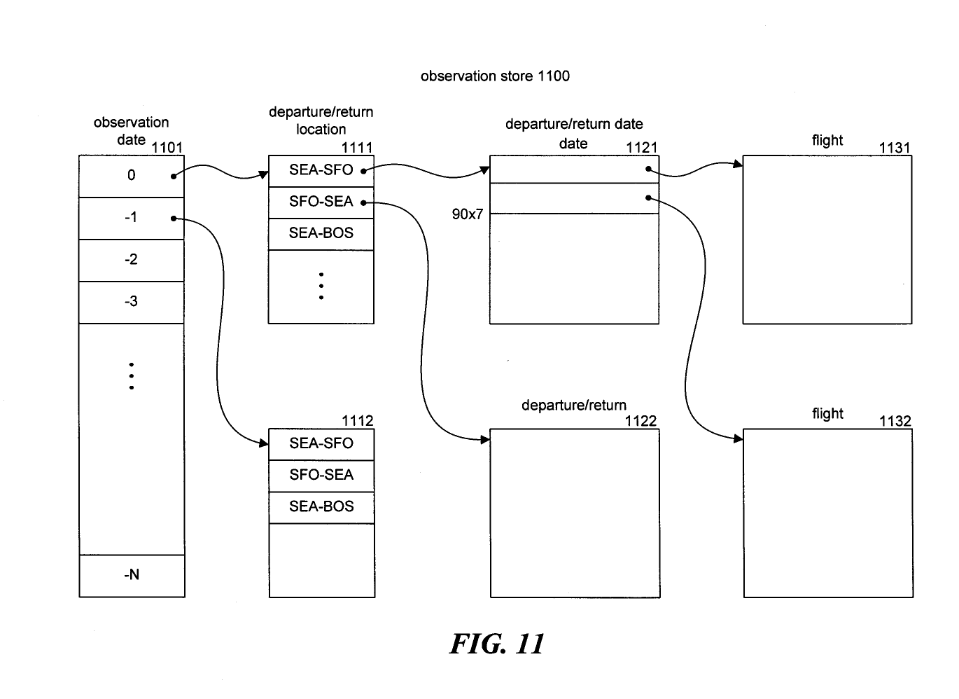

FIG. 11 is a block diagram that illustrates data structures of an observation store in one embodiment. The observation store 1100 includes an observation date table 1101 that contains an entry for each observation date starting with the most current observation date. Each entry contains a reference to a departure/return location table 1111-1112. Each departure/return location table contains an entry for each departure location and return location combination that contains a reference to a departure/return date table 1121-1122. Each departure/return date table contains an entry for each possible trip with the associated departure/return location. A trip represents a unique combination of departure date and return date for a departure location and return location combination. Each entry identifies the departure/return date of the trip and contains a reference to a flight table 1131-1132. Each flight table contains an entry for each flight for the trip identified by the associated departure and return location and date. Each entry of the flight table may contain the raw flight information collected from a flight information source by a fetch observations component (not shown).

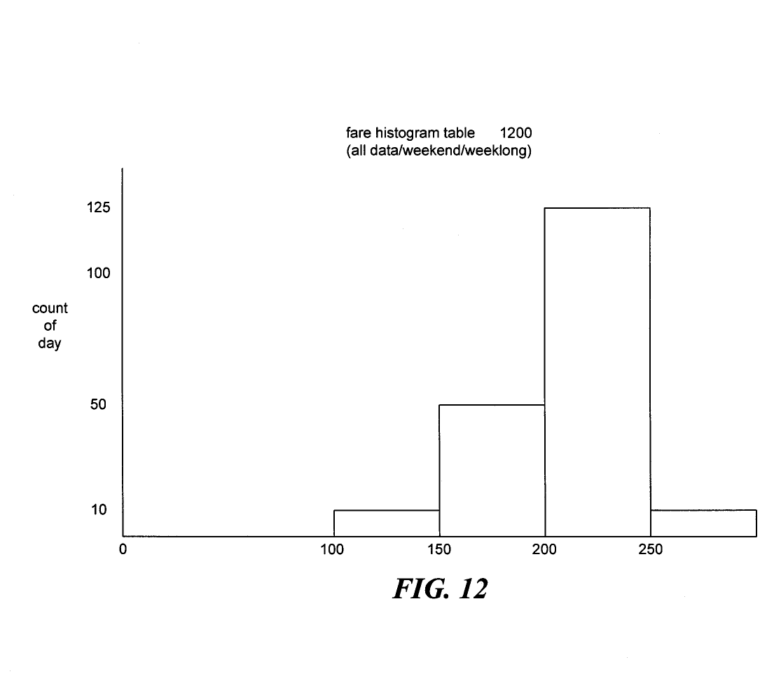

FIG. 12 is a diagram that illustrates a fare histogram. The fare histogram 1200 may be created for various categorizations of trips such as weekend trips and weeklong trips. The fare histogram has a fare level axis and a count of dates axis. Each bar indicates the number of days that the price was at that fare level. For example, in the price range between $100 and $150, the total number of days at which the lowest fare for that market and trip category was at that price level was 10.

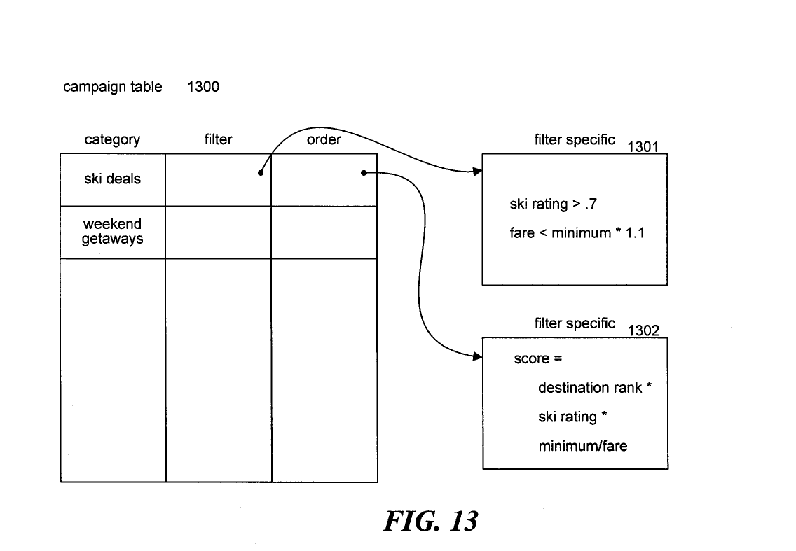

FIG. 13 is a block diagram that illustrates a campaign table 1300 of the campaign service. The campaign table 1300 contains an entry for each category of deals (e.g., ski deals or wine country deals). The deal identification system may maintain a campaign table for each campaign. Each entry of the campaign table includes a category, a filter specification 1301, and an order specification 1302. The category field contains the name of the deal category. The filter specification field contains the filter specification, and the order specification field contains the order specification for ranking the deals. In this example, the filter specification indicates that a ski deal is a flight to an airport with a ski rating above 0.7 with a current fare that is within 10% of the all-time low. The order specification indicates that the score is a combination of the rank of the destination airport, the ski rating, and the ratio of the current fare to the all-time lowest fare.

The computing devices on which the deal identification system may be implemented may include a central processing unit, memory, input devices (e.g., keyboard and pointing devices), output devices (e.g., display devices), and storage devices (e.g., disk drives). The memory and storage devices are computer-readable media that may contain instructions that implement the deal identification system. In addition, the data structures may be stored or transmitted via a data transmission medium, such as a signal on a communications link. Various communications links may be used to connect the deal identification system to flight information sources and user computing devices, such as the Internet, a local area network, a wide area network, a point-to-point dial-up connection, a cell phone network, and so on.

Embodiments of the deal identification system may be implemented in various operating environments that include personal computers, server computers, multiprocessor systems, microprocessor-based systems, minicomputers, mainframe computers, distributed computing environments that include any of the above systems or devices, and so on. The user devices may include cell phones, personal digital assistants, smart phones, personal computers, programmable consumer electronics, digital cameras, and so on.

The deal identification system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments. For example, the functions of batch collection and providing the user interface may be performed on different computer systems.

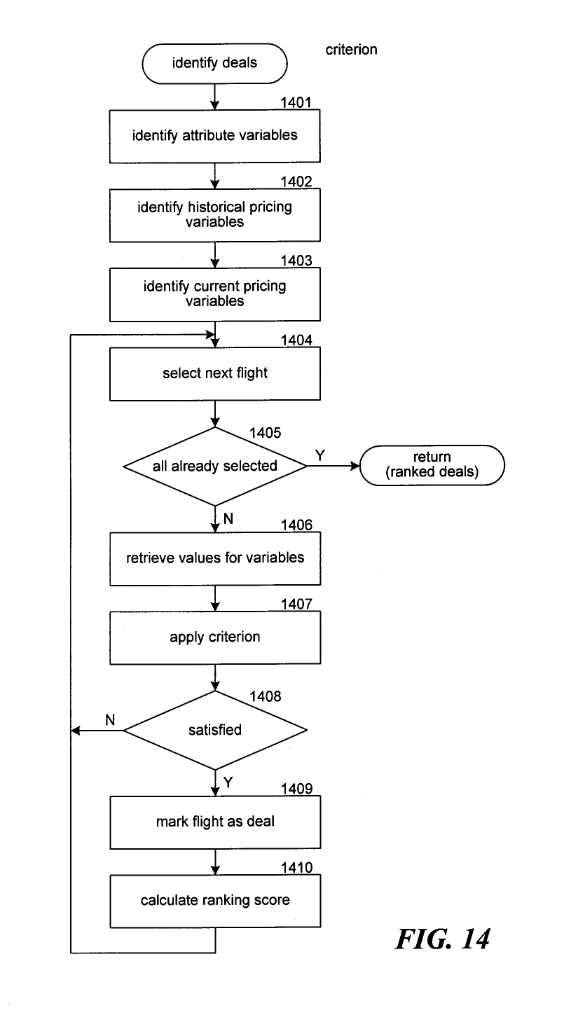

FIG. 14 is a flow diagram that illustrates the processing of an identify deals component of the deal identification system in some embodiments. The component is passed a criterion that includes a filter and an order expression and returns deals as defined by that criterion in ranked order. In block 1401, the component identifies attribute variables from the filter and order expression of the criterion. In block 1402, the component identifies historical pricing variables used in the expression of the criterion. In block 1403, the component identifies current pricing variables used in the expression of the criterion. In blocks 1404-1410, the component loops identifying which flights are deals and calculating a ranking score for those flights. In block 1404, the component selects the next flight. In decision block 1405, if all the flights have already been selected, then the component returns the ranked deals, else the component continues at block 1406. In block 1406, the component retrieves values for the identified variables. In block 1407, the component applies the filter expression of the criterion to the retrieved values. In decision block 1408, if the filter expression is satisfied, then the component continues at block 1409, else the component loops to block 1404 to select the next flight. In block 1409, the component marks a selected flight as a deal. In block 1410, the component applies the order expression of the criterion to calculate a ranking score for the selected flight. The component then loops to block 1404 to select the next flight.

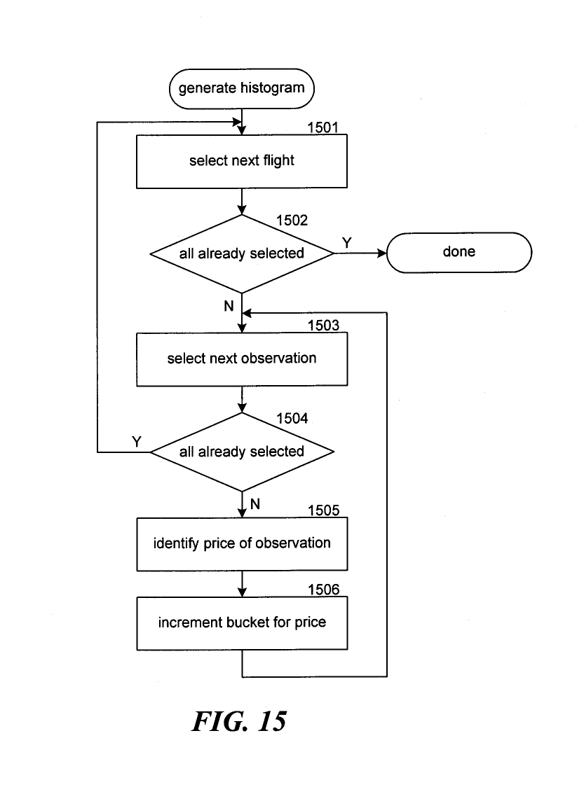

FIG. 15 is a flow diagram that illustrates the processing of a generate histogram component of the deal identification system in some embodiments. The component generates a histogram for historical pricing information of flights. In block 1501, the component selects the next flight. In decision block 1502, if all the flights have already been selected, then the component completes, else the component continues at block 1503. In block 1503, the component selects the next observation for the selected flight. In decision block 1504, if all the observations for the selected flight have already been selected, then the component loops to block 1501 to select the next flight, else the component continues at block 1505. In block 1505, the component identifies the price of the selected observation. In block 1506, the component increments the bucket of the histogram within which the identified price falls and then loops to block 1503 to select the next observation.

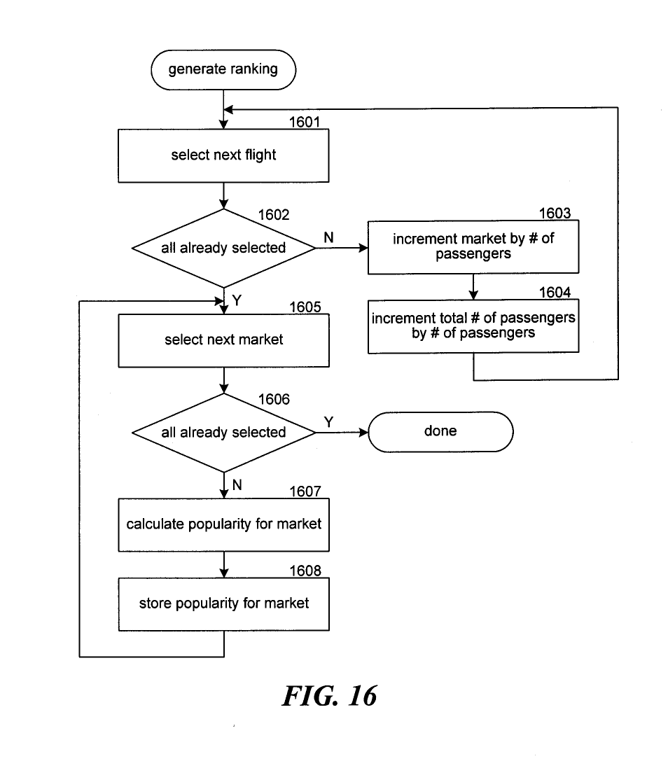

FIG. 16 is a flow diagram that illustrates the processing of a generate ranking component of the deal identification system in some embodiments. The component ranks the popularity of various airline markets. In blocks 1601-1604, the component loops accumulating a count of the number of passengers who travel in each airline market. In block 1601, the component selects the next flight. In decision block 1602, if all the flights have already been selected, then the component continues at block 1605, else the component continues at block 1603. In block 1603, the component increments the number of passengers for the market associated with the selected flight by the number of passengers of the selected flight. In block 1604, the component increments the total number of passengers by the number of passengers of the selected flight. The component then loops to block 1601 to select the next flight. In blocks 1605-1608, the component loops calculating the popularity for each market. In block 1605, the component selects the next market. In decision block 1606, if all the markets have already been selected, then the component completes, else the component continues at block 1607. In block 1607, the component calculates the popularity of the selected market by, for example, dividing the number of passengers for that market by the total number of passengers. In block 1608, the component stores the popularity for the selected market and then loops to block 1605 to select the next market.

### Deal Criteria

Deal expressions are used as a part of a deal criterion to filter and sort markets and deals returned by the deals service. The syntax of a deal expression is SQL-like and allows referencing a number of properties of the market, origin, destination, observation, price prediction (see, U.S. Pat. No. 7,010,494, entitled “Performing Predictive Pricing Based on Historical Data” and issued on Mar. 7, 2006), and fare guard offer (see, U.S. patent application Ser. No. 11/599,607, entitled “System and Method of Protecting Prices” and filed on Nov. 13, 2006).

The filter consists of a single expression and evaluates to true or false. It is analogous to a SQL “where” clause. An example of a filter is:

market.distance<1000 and market.rank<100 and (dest.tag[Ski] or dest.tag[Disney])

Only markets/deals for which the filter evaluates to true will appear in the results.

The sorter or order specification is a comma-separated list of expressions with sort modifiers (ascending/descending). It is analogous to a SQL “order by” clause. An example sorter is:

hist_percentile, hist_low_delta, market.weight*dest.tag[Ski] desc

Markets in the results are sorted according to the list of values from an evaluation of sorter expressions. As an example, if there were three markets matching the above filter, for which the above sorter evaluated as follows:
SEABOS {10, 5.00, 0.5}
SEADEN {20, 15.00, 0.3}
SEAORD {20, 15.00, 0.6}
   SEABOS will appear first, as it has the lowest first sort value (10). SEADEN and SEAORD have the same first and second values, so the third value is used for sorting. Since the third expression specifies descending sorting, SEAORD will sort before SEADEN. If sort expressions are not supplied, or if all sort expressions evaluate to the same list of values for two markets, the order is determined by the market name.

### Syntax

The syntax for the deal expressions is defined as:

1. Data Types
The following data types are currently supported: NUMERIC (floating point numbers), BOOLEAN (true/false), and TEXT. The data types are not specified explicitly but rather implied from the referenced properties, literal values, expressions, or functions.

2. Literal values
Numeric literals: 1000, 20.5, 0.05. Exponents (e.g., 1E-3) may be supported. Boolean literals: true, false. Text literals are enclosed in single quotes, e.g., ‘FL,’ ‘BOS.’ If a single quote is specified within a text literal then a distinguished character may be used to indicate that the following single quote is part of the literal.

3. Property references
Properties are referenced by an (optionally prefixed) name. The deals identification may define a set of properties obtained from a number of data sources. The properties may include observation, offer (prediction/fare guard), market, origin, and destination.
   3.a Observation/Offer Property References
   Observation and offer properties are referenced with an unqualified name. The observation and offer properties are indicated by the following table:

| Name | Type | Description |
|---|---|---|
| price | NUMERIC | The observed price |
| days_to_dep | NUMERIC | Days to departure |
| stay | NUMERIC | Days stayed |
| dep_interval | NUMERIC | Departure interval (1 through 6) |
| ret_interval | NUMERIC | Return interval (1 through 6) |
| pred_level | NUMERIC | Corresponds to barometer prediction: |
| | | 1 for DOWN through 5 for UP |
| fareguard_offered | BOOLEAN | Whether fare guard is offered |
| hist_percentile | NUMERIC | Historical percentile of observed |
| | | price (0 through 100) |
| hist_low_delta | NUMERIC | Difference between observed price |
| | | and historical low price |
| | | (dollar amount) |
| hist_mean_delta | NUMERIC | Difference between observed price |
| | | and historical mean price |
| | | (dollar amount) |
| curr_percentile | NUMERIC | Current percentile of observed price |
| | | (0 through 100) |
| curr_low_delta | NUMERIC | Difference between observed price |
| | | and current low price |
| | | (dollar amount) |
| curr_mean_delta | NUMERIC | Difference between observed price |
| | | and current mean price |
| | | (dollar amount) |

Statistical properties (starting with hist_* and curr_*) are evaluated by default in the observation domain specified in the criteria. Different observation domains can be specified as follows: hist_percentile[weekend].
3.b Market Property References
Market property references are prefixed with “market” (e.g., marketcode). The market property references are indicated by the following table:

| Name | Type | Description |
|---|---|---|
| code | TEXT | Market code (e.g., SEABOS) |
| distance | NUMERIC | Distance in miles |
| flight_hours | NUMERIC | Estimated non-stop flight time (at 530 mph) |
| international | BOOLEAN | True if origin and destination are in |
| | | different countries |

3.c Origin/Destination Property References
Origin and destination references are prefixed with “orig” and “dest,” respectively (e.g., dest.city_population). Origin and destination properties are indicated by the following table:

| Name | Type | Description |
|---|---|---|
| code | TEXT | Airport code (e.g., SEA) |
| name | TEXT | Airport name (e.g., Seattle-Tacoma |
| | | International) |
| city_code | TEXT | City code (currently not IATA standard) |
| city_name | TEXT | City name |
| city_population | NUMERIC | City population |
| state_code | TEXT | State code (e.g., WA) |
| country_code | TEXT | Country code (e.g., USA) |
| latitude | NUMERIC | Latitude (degrees) |
| longitude | NUMERIC | Longitude (degrees) |
| time zone | TEXT | Standard time zone name |
| time zone_offset | NUMERIC | Time zone offset from UTC in |
| | | hours (without DST) |

4. Ranking Properties
In addition to the above properties, the deals identification system has several ranking properties for markets, origins, and destinations. The ranking properties are indicated in the following table:

Name Type Description

rank NUMERIC Rank (1 is the highest)

weight NUMERIC Weight among all ranked entities in the domain (0 to 1)

points NUMERIC Number of recorded searches
The above properties are taken from rankings in the same observation domain as specified in the criteria. Different observation domains can be specified as follows: dest.rank[weekend].

5. Tags
Tags can be specified for market (market tags) and origin/destination (airport tags). The tag name is specified in square braces: market.tag[Some Tag Name], desttag[Ski]. Depending on the expression or function where they are used, tag references may evaluate to BOOLEAN or NUMERIC type. BOOLEAN tag references evaluate to true if market or airport are tagged with the specified tag at non-zero level. NUMERIC tag references evaluate to the tagging level (0 if not tagged).

6. Boolean Operators
Boolean operators take one or two BOOLEAN operands and evaluate to BOOLEAN. One operand: not. Two operands: and, or, xor (exclusive or). Example: dest.tag[Ski] or dest.tag[Disney].

7. Numeric Operators
Numeric operators take one or two NUMERIC operands and evaluate to NUMERIC. Single operand: negation (−). Two operands: addition (+), subtraction (−), division (/), multiplication (*), modulo division (%), power (̂). Division (and modulo division) by zero evaluates to NULL.

8. Comparison Operators
Comparison operators (=, < >, <, <=, >, >=) take two operands of the same type and evaluate to BOOLEAN.
TEXT operands are compared according to ASCII. The following comparisons evaluate to true: ‘A’<‘B’, ‘a’ >‘A’, ‘0’<‘A’, ‘AA’ >‘A’.
For BOOLEAN operands, true is greater than false.

9. “Between” Operator
The between operator takes the form of x between y and z and is equivalent to x >=y and x<=z.

10. “In” Operator
The “in” operator evaluates to BOOLEAN and tests whether the first operand is contained in or equal to any operands in the following list (analogous to SQL). All operands may be of the same type. An example of use of the “in” operator is dest.state_code in (‘FL’, ‘CA’, orig.state_code).

11. Case statement
A case statement tests a series of conditions and expressions in the form of when <condition> then <expression>, and evaluates to the first expression whose condition evaluates to true (analogous to SQL). If none of the conditions evaluates to true, the statement evaluates to the “else” expression. An example of a use of the case statement is case when market.international then 5 when dest.tag[Ski] then 4 else 1 end.

12. Functions
The deals identification system supports the functions indicated in the following table:

| Name | Type | Example |
|---|---|---|
| abs | NUMERIC | Absolute value: abs(dest.latitude) |
| ceil | NUMERIC | Round up: ceil(price) |
| floor | NUMERIC | Round down: floor(price) |
| min | NUMERIC | Minimum (2 or more args): min(hist_percentile, |
| | | curr_percentile, 20) |
| max | NUMERIC | Maximum (2 or more args): min(hist_percentile, |
| | | curr_percentile, 20) |
| ifnull | any | Evaluates to the second argument if the first |
| | | argument is NULL: ifnull(pred_level, 3) |
| log | NUMERIC | Natural logarithm: log(market.points) |
| log10 | NUMERIC | Base-10 logarithm: log10(market.points) |

13. Operator Precedence and Grouping
Operator precedence is as follows:
   1. *, /, %
   2. +, −
   3. <, <=, >, >=, =, < >, between, in
   4. and, or, xor
   5. case
Operators may be grouped with parentheses: x and (y or z)

14. Sort Modifiers
The asc (default) and desc modifiers specify ascending and descending sorting. Optionally, null high (default) or null low can be added to control how NULL values sort relative to non-NULL values.

15. Missing Data (NULL Values)
NULL values may appear during evaluation from missing data or as a result of division by zero.
A numeric expression or function having NULL as one of its operands or arguments evaluates to NULL. The following Boolean expressions evaluate to NULL: NULL or false, NULL and true. Also, comparisons having NULL as one of the operands evaluate to NULL (including NULL=NULL).
If the whole filter expression evaluates to NULL, the filter is considered not passed and the corresponding market will not be added to the results.
If a value in one of the sorter expressions evaluates to NULL, it is sorted after non-NULL values, unless null low is specified in the modifier.
Testing for NULL (evaluates to BOOLEAN): is null, is not null.

16. Case Sensitivity
Keywords (operators, statements, etc.) are case-insensitive. Function names and property references are case-sensitive.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A deal identification system that identifies deals for items, the system comprising:
an entity attributes service component that provides attributes of entities associated with the items;
a historical price service component that provides historical pricing information for the items;
a current price service component that provides current pricing information for the items; and
a deal component that receives a criterion that defines a deal based on a combination of attributes of entities, historical pricing information, and current pricing information and identifies those items that match the criterion as deals.

2. The deal identification system of claim 1 wherein the items are airline flights and the entities are departure and destination airports.

3. The deal identification system of claim 1 wherein the items are hotel rooms and the entities are destination cities.

4. The deal identification system of claim 1 wherein the items are travel-related items.

5. The deal identification system of claim 1 including a campaign service component that provides a user interface for specifying criteria that define deals and submits the criteria to the deal component.

6. The deal identification system of claim 1 wherein the historical price service component generates a histogram for an item with buckets for a price range that indicates a count of times the price for the item was within that price range.

7. The deal identification system of claim 6 wherein the count represents the number of days that the price was in the price range of the bucket.

8. The deal identification system of claim 1 wherein an entity tagging service allows an administrator to define attributes for the entities.

9. The deal identification system of claim 1 wherein the entity attributes service component includes an entity ranking service that ranks entities based on popularity.

10. The deal identification system of claim 1 wherein the entity attributes service component includes an entity tagging service that allows a user to specify values for attributes of an entity.

11. The deal identification system of claim 1 wherein a deal is further based on non-pricing attributes of the item.

12. A method in a computing device for identifying deals for an item, the method comprising:
providing a criterion that defines items that match the criterion and defines a deal for the matching items based on non-pricing attributes of the matching items;
identifying the items that match the criterion;
for each matching item,
evaluating the attributes of the matching item to determine whether the item is a deal; and
when the evaluation indicates that the matching item is a deal identifying the matching item as a deal; and
providing an indication of those items that are items that are identified as deals.

13. The method of claim 12 wherein the items are airline flights, matching items are airline flights having the same departure and destination cities, and the non-pricing attributes are derived from physical characteristics of the airplane used for the flight.

14. The method of claim 12 wherein the items are airline flights, matching items are airline flights having the same departure and destination cities, and the non-pricing attributes are derived from characteristics of the airline that provides the flight.

15. The method of claim 12 wherein the items are airline flights, matching items are airline flights having the same departure and destination cities, and the non-pricing attributes are derived from characteristics of services provided with the airline flight.

16. The method of claim 12 wherein a deal is further based on attributes derived from historical pricing information.

17. The method of claim 12 wherein the items are hotel rooms, matching items are hotel rooms associated with the same location, and the non-pricing attributes include physical characteristics of the hotel rooms.

18. The method of claim 12 wherein the items are hotel rooms, matching items are hotel rooms associated with the same location, and the non-pricing attributes include amenities of the hotel.

19. A computer-readable medium containing instructions for controlling a computing device to identify deals for items, by a method comprising:
providing a criterion that defines items that match a criterion and defines a deal for the matching item based on current and historical pricing information;
identifying the items that match the criterion;
for each matching item,
evaluating current and historical pricing information of the matching item to determine whether the item is a deal; and
when the evaluation indicates that the matching item is a deal identifying the matching item as a deal; and
providing an indication of those items that are items that are identified as deals.

20. The computer-readable medium of claim 19 wherein a deal is further based on non-pricing attributes of an item.
